(19) United States
(12) Patent Application Publication
(10) Pub. No.: US 2019/0104436 A1
(43) Pub. Date: Apr. 4, 2019

(54) COMMUNICATION DEVICE AND PACKET TRANSMISSION METHOD THEREOF

(71) Applicant: Electronics and Telecommunications Research Institute, Daejeon (KR)

(72) Inventors: Yoo Seung SONG, Daejeon (KR); Do Wook KANG, Daejeon (KR); Hyun Seo OH, Daejeon (KR); Shin Kyung LEE, Daejeon (KR); Jeong Woo LEE, Daejeon (KR); Hyun Kyun CHOI, Daejeon (KR)

(73) Assignee: Electronics and Telecommunications Research Institute, Daejeon (KR)

(21) Appl. No.: 15/865,838

(22) Filed: Jan. 9, 2018

(30) Foreign Application Priority Data
Sep. 29, 2017 (KR) 10-2017-0127570

(51) Int. Cl. H04W 28/02; H04W 72/12; H04W 4/46; H04W 28/04

(52) U.S. Cl. CPC H04W 28/0289; H04W 72/1205; H04W 72/1263; H04W 28/0247; H04W 28/04; H04W 4/46

(57) ABSTRACT

Provided is a packet transmission method of a communication device. The packet transmission method includes randomly determining a first packet transmission time of a first packet which is to be transmitted in an nth beacon interval, generating the first packet, and transmitting the first packet at the first packet transmission time.

### CROSS-REFERENCE TO RELATED APPLICATIONS

This application claims priority under 35 U.S.C. § 119 to Korean Patent Application No. 10-2017-0127570, filed on Sep. 29, 2017, the disclosure of which is incorporated herein by reference in its entirety.

### TECHNICAL FIELD

The present invention relates to a communication device and a packet transmission method thereof, and more particularly, to a communication device and a packet transmission method thereof, which broadcast a message in a wireless network environment.

### BACKGROUND

Recently, intelligent transport system (ITS) which solves problems such as traffic accidents and traffic jams by applying communication technology to vehicles is being developed.

The ITS may provide various application services by using all types of communication technologies, which are capable of being applied to vehicles, such as vehicle-to-vehicle communication (V2V), vehicle-to-infra communication (V2I), vehicle-to-nomadic devices communication (V2N), etc.

In detail, in order to prevent an accident between vehicles, vehicles periodically broadcast broadcasting messages (or safety messages), including basic information such as their position, speed, direction, and the like, to surrounding vehicles by using the ITS to which V2V, V2I, or V2N is applied, and the surrounding vehicles which have received the broadcasting messages share the received broadcasting messages and use the broadcasting messages for securing a safety distance between vehicles or generating a route for autonomous driving.

If the number of vehicles for broadcasting the broadcasting messages increases, a collision probability that collision occurs between the broadcasting messages in a wireless communication channel increases, and as a time for which packets stand by in a transmission buffer increases, a delay increases.

In a vehicle-to-vehicle communication environment having no infrastructure (for example, a vehicle-to-vehicle communication environment having no specific coordinator such as a base station), a communication device included in each of vehicles should autonomously recognize a wireless channel environment (or a wireless channel environment) to solve problems of a packet collision and a delay caused by the increase in broadcasting messages.

FIG. 1 illustrates a related art method of transmitting beacon messages according to IEEE 802.11 standard and is a diagram for describing a method of preventing a packet collision when communication devices transmit a beacon message.

Referring to FIG. 1, communication devices each including a packet to transmit generate the packet, calculates a random delay (DI) at every periodical beacon interval, and broadcasts the packet by using a backoff algorithm based on distributed coordination function (DCF). That is, the related art method of transmitting beacon messages is performed in the order of a packet generating operation, a random delay calculating operation, a backoff DCF executing operation, and a wireless transmission operation.

The related art method of transmitting beacon messages uses a method of distributing a packet transmission time through a random delay at a start point of a beacon interval to avoid a packet collision between communication devices. However, the method has a problem where a packet generated in a previous interval is not immediately transmitted at a start point of a current beacon interval, and an additional delay equal to a random delay is further needed.

### SUMMARY

Accordingly, the present invention provides a communication device and a packet transmission method thereof, which transmit a message through a self-decision-based packet transmission method for decreasing a transmission delay and a packet collision in a case where communication devices periodically transmit messages.

In one general aspect, a packet transmission method of a communication device includes: randomly determining a first packet transmission time of a first packet which is to be transmitted in an nth beacon interval; generating the first packet; and transmitting the first packet at the first packet transmission time.

In another general aspect, a communication device includes: a controller randomly determining a first packet transmission time of a first packet which is to be transmitted in an nth beacon interval, and generating the first packet; and a communicator immediately transmitting the generated first packet at the first packet transmission time without transmission standby.

Other features and aspects will be apparent from the following detailed description, the drawings, and the claims.

### BRIEF DESCRIPTION OF THE DRAWINGS

FIG. 1 is a diagram illustrating a related art method of transmitting beacon messages according to IEEE 802.11 standard and for describing a method of preventing a packet collision when communication devices transmit a beacon message.

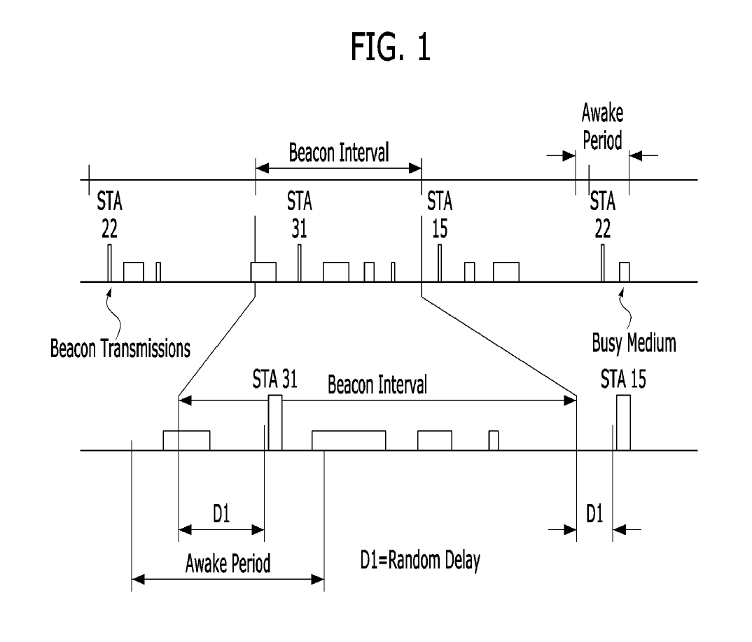

FIG. 2 is a diagram schematically illustrating a method of transmitting, by a communication device according to an embodiment of the present invention, a packet at a packet transmission time determined based on self-decision.

FIG. 3 is a diagram schematically illustrating a method of transmitting, by a communication device according to another embodiment of the present invention, a packet at a packet transmission time determined based on self-decision.

FIG. 4 is a block diagram schematically illustrating an internal configuration of a communication device according to an embodiment of the present invention.

FIG. 5 is a flowchart illustrating a packet transmission method according to an embodiment of the present invention.

### DETAILED DESCRIPTION OF EMBODIMENTS

Hereinafter, example embodiments of the present invention will be described in detail with reference to the accompanying drawings. Embodiments of the present invention are provided so that this disclosure will be thorough and complete, and will fully convey the concept of the present invention to one of ordinary skill in the art. Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout.

Communication Environment to Which the Present Invention is Applied

A packet transmission method of a communication device according to an embodiment of the present invention may be applied to a communication environment where a plurality of communication devices periodically broadcast (or transmit) their messages in a network environment having no coordinator such as an access point or a base station. Here, the message may be replaced with the term “broadcasting message”. Also, the message may be divided into a plurality of data blocks each having a predetermined size, and each of the data blocks may be defined as a packet. Therefore, the message may be replaced with the term “packet”. In the present specification, unless specially described, a message and a packet may be regarded as the same term and may be used as the same meaning.

In a case where an embodiment of the present invention is applied to a specific communication field, the broadcasting message may be replaced with various terms depending on the specific communication field. For example, in a case where an embodiment of the present invention is applied to V2V, the broadcast message may be referred to as a safety message.

The communication environment may be, for example, a wireless ad-hoc network or an independent basic service set (IBSS) included in IEEE 802.11 standard.

It may be assumed that the communication network is a communication environment having one hop distance, and there is no error in time synchronization between all communication devices in the same network.

In such a communication environment, in order to minimize a packet collision and a packet transmission delay, communication devices according to an embodiment of the present invention may determine a packet transmission time based on self-decision and may broadcast a broadcasting message, based on the determined packet transmission time.

Hereinafter, a method of determining a packet transmission time based on self-decision according to an embodiment of the present invention will be described in detail with reference to the accompanying drawings.

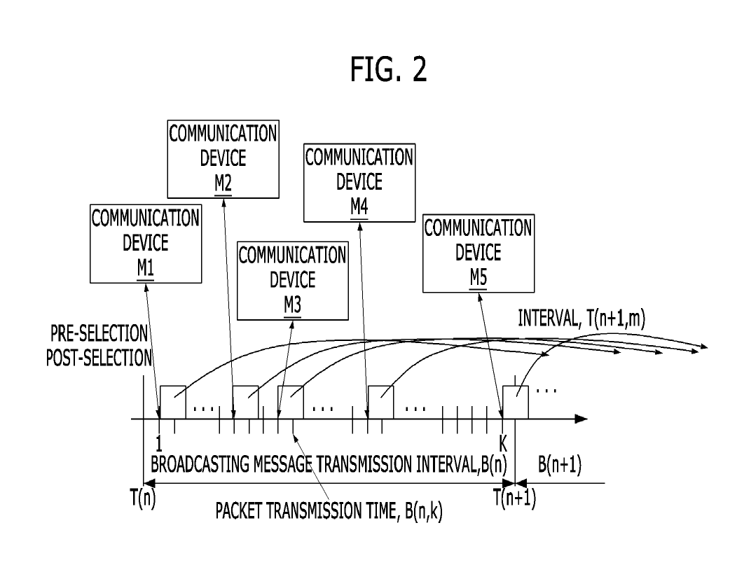

FIG. 2 is a diagram schematically illustrating a method of transmitting, by a communication device according to an embodiment of the present invention, a packet at a packet transmission time determined based on self-decision.

Referring to FIG. 2, a method of determining a packet transmission time according to an embodiment of the present invention may be a method of determining a packet transmission time in a case where a beacon interval enabling transmission of a broadcasting message is continuous.

Reference numeral B(n) refers to an nth beacon interval which enables a plurality of communication devices to transmit a broadcasting message.

Reference numeral B(n+1) refers to an n+1st beacon interval which enables a plurality of communication devices to transmit a broadcasting message, and is a beacon interval succeeding B(n) on a time axis.

B(n) and B(n+1) may each include a plurality of time slots which are continuous on the time axis.

In FIG. 2, five communication devices M1 to M5 are illustrated. This is for conscience of the drawing, and an embodiment of the present invention is not limited to a method of determining a packet transmission time in the five communication devices M1 to M5.

Reference numeral k refers to an indicator indicating a packet transmission time determined by a communication device. Therefore, B(n, k) refers to a kth packet transmission time or a kth time slot in the beacon interval B(n).

In an embodiment of the present invention, the communication devices M1 to M5 may determine a packet transmission time B(n, k) of a first packet in the nth beacon interval B(n), based on self-decision.

In detail, each of the communication devices may randomly determine a packet transmission time B(n, k) of an nth packet in the packet beacon interval B(n) by using a random function, for determining the packet transmission time B(n, k) of the first packet based on self-decision.

Therefore, five packet transmission times B(n, k₁), B(n, k₂), B(n, k₃), B(n, k₄), and B(n, k₅) determined by the communication devices M1 to M5 may be randomly distributed in the beacon interval B(n). Accordingly, a packet collision between the communication devices M1 to M5 in the beacon interval B(n) is prevented.

When the packet transmission time B(n, k) of the first packet is determined in the nth beacon interval B(n), each communication device may generate the first packet which is to be transmitted at the packet transmission time B(n, k). That is, unlike the related art where a packet is generated and then a random delay is calculated at every beacon interval, according to an embodiment of the present invention, the packet transmission time B(n, k) of the first packet may be determined so as to be randomly distributed in the beacon interval B(n), and then, the first packet may be generated and may be transmitted at the determined packet transmission time B(n, k).

Unlike the related art, according to an embodiment of the present invention, since a packet is generated after a packet transmission time B(n, k) is determined, it is not required for a packet, generated before calculating a random delay, to stand by in a transmission buffer in the middle of calculating a random delay. Accordingly, according to an embodiment of the present invention, a transmission delay is reduced.

As described above, when the first packet is randomly determined in the nth beacon interval B(n), a packet transmission time B(n+1, k) of a second packet which is to be transmitted in an n+1st beacon interval B(n+1) may be determined based on an interval value T(n+1, m) which is set for each communication device. That is, the packet transmission time B(n+1, k) of the second packet which is to be allocated to an n+1st beacon interval B(n+1) may be calculated by moving the packet transmission time B(n, k) of the first packet by the interval value T(n+1, m). Here, T(n+1, m) denotes an interval value which is applied to an n+1st beacon interval B(n+1) for an mth communication device.

A packet transmission time which is determined according to an embodiment of the present invention may be determined irrespective of a packet transmission time which is determined before a time when a communication device is reset or turned on. That is, a packet transmission time which is determined before a time when a communication device is reset or turned on may be the same as or different from a packet transmission time which is determined after the time.

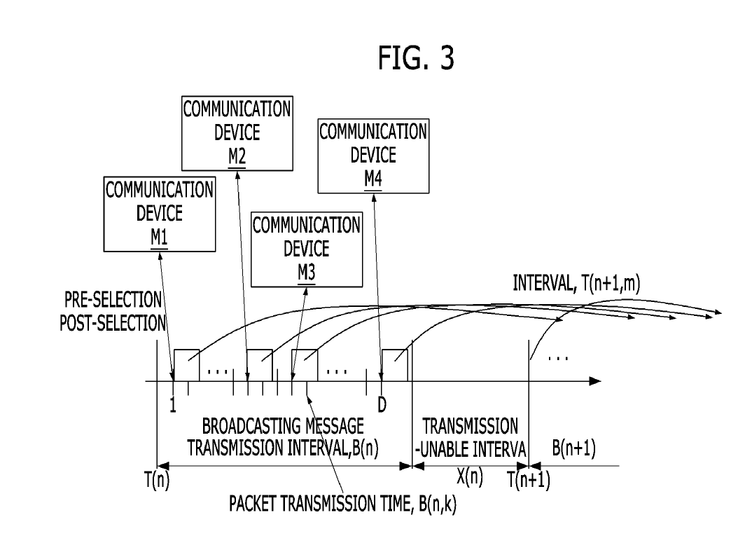

FIG. 3 is a diagram schematically illustrating a method of transmitting, by a communication device according to another embodiment of the present invention, a packet at a packet transmission time determined based on self-decision.

Referring to FIG. 3, a method of determining a packet transmission time according to another embodiment of the present invention may be a method of determining a packet transmission time in a case where a beacon interval enabling transmission of a broadcasting message is discontinuous. Here, a discontinuous beacon interval denotes an interval where a transmission-unable interval X(n) is between a beacon interval B(n) and a beacon interval B(n+1).

When a beacon interval is discontinuous, communication devices M1 to M4 may determine a packet transmission time B(n, d) of a first packet in the beacon interval B(n) by using the same method as the above-described continuous beacon interval, based on self-decision. That is, each of the communication devices M1 to M4 may randomly determine the packet transmission time B(n, d) of the first packet by using a random function include therein so as to be randomly distributed in the beacon interval B(n).

When the packet transmission time B(n, d) is randomly determined, each of the communication devices M1 to M4 may generate the first packet and may transmit the generated first packet at the determined packet transmission time B(n, d).

A second packet which is to be transmitted second after the first packet may be determined in an n+1st beacon interval B(n+1) according to an interval set in each communication device by using the same method as the method described above in the embodiment of FIG. 2. In this case, when a packet transmission time B(n+1, d) of the second packet which is to be transmitted by an arbitrary communication device is allocated to an nth transmission-unable interval X(n) succeeding the nth beacon interval B(n) instead of the n+1st beacon interval B(n+1), a packet transmission time of the second packet which is to be transmitted by a corresponding communication device may be determined so as to be reallocated to the n+1st beacon interval B(n+1) succeeding the nth beacon interval B(n) without being determined in the nth transmission-unable interval X(n).

A method of determining the packet transmission time B(n+1, d) of the second packet in the n+1st beacon interval B(n+1) may use a modulo function. For example, a remaining time C corresponding to a remainder obtained by dividing a next packet transmission time A by a beacon interval B may be determined as a packet transmission time in a broadcasting message beacon interval B(n+1) subsequent thereto. Such a method is merely an embodiment, and the packet transmission time B(n+1, k) of the second packet may be determined in the beacon interval B(n+1) by using another method. For example, the packet transmission time B(n+1, k) of the second packet may be determined in the beacon interval B(n+1) by using the random function in the beacon interval B(n+1).

In the embodiments of FIGS. 2 and 3, a method of randomly determining a packet transmission time of each communication device and generating and transmitting a packet without sensing a channel state has been described. On the other hand, each communication device may determine a packet transmission time, based on a result obtained by sensing a channel state.

In a method of determining a packet transmission time based on sensing of a channel state according to another embodiment of the present invention, a communication device may first determine a packet transmission time, based on a result obtained by sensing a channel state in a beacon interval or a packet transmission time (a time slot) in the beacon interval and may transmit a generated packet at the determined packet transmission time according to the channel state.

That is, in a method of determining a packet transmission time according to another embodiment of the present invention, each communication device may obtain available channel time information, based on a result obtained by sensing a channel state and may select a packet transmission time B(n, k) or B(n, d) in a continuous beacon interval or a discontinuous beacon interval. Here, the result obtained by sensing the channel state may include, for example, idle time slot information, congestion information, etc. A method of sensing a channel state is not a feature of the present invention, and thus, technology known to those skilled in the art is applied to a description of the method.

In another embodiment of the present invention, a method of determining, by each communication device, a packet transmission time B(n, k) or B(n, d) of a first packet and determining a packet transmission time B(n+1, k) or B(n+1, d) of a second packet according to a predetermined interval is the same as the method described above in the embodiments of FIGS. 2 and 3.

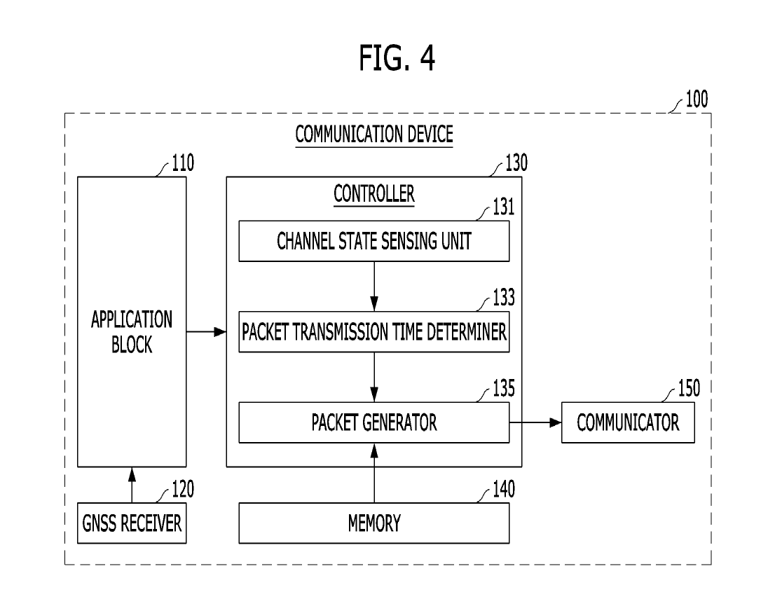

FIG. 4 is a block diagram schematically illustrating an internal configuration of a communication device 100 according to an embodiment of the present invention.

Referring to FIG. 4, the communication device 100 according to an embodiment of the present invention may have a communication function so as to perform wireless communication in a network environment having no coordinator such as an access point or a base station.

For example, the communication device 100 may perform wireless communication in a network environment defined in IEEE 802.11 standard. The network environment may be referred to as, for example, a wireless ad-hoc network or an independent basic service set (IBSS).

The communication device 100 according to an embodiment of the present invention may intelligently determine a packet transmission time of a broadcasting message, based on self-decision, thereby decreasing a packet collision and a transmission delay.

To this end, the communication device 100 according to an embodiment of the present invention may include an application block 110, a GNSS receiver 120, a controller 130, a memory 140, and a communicator 150.

The application block 110 may transfer data and time information, which is received from a satellite through the GNSS receiver 120, to the controller 130.

The controller 130 may fundamentally control channel access, determine a packet transmission time of a broadcasting message based on self-decision, generate a packet according to the determined packet transmission time, and transfer the generated packet to the communicator 150.

When the data and the time information are input from the application block 110, the controller 130 may perform a series of processing operations in the order of a packet transmission time determining operation, a packet generating operation, and a packet transmitting operation, for broadcasting a broadcasting message corresponding to the data. In order to perform the processing operations, the controller 130 may be implemented with various hardware, and for example, may be implemented with one or more general-use microprocessors, digital signal processors (DSPs), hardware cores, application specific integrated circuits (ASICs), field programmable gate arrays (FPGAs), or a combination thereof.

The controller 130 implemented with hardware may include a plurality of blocks divided by processing operations, and for example, may include a channel state sensing unit 131, a packet transmission time determiner 133, and a packet generator 135.

The channel state sensing unit 131 may sense a channel state and may transfer a result of the sensing to the packet transmission time determiner 133. Here, the sensing of the channel state may be selectively performed according to a selection by a user.

The packet transmission time determiner 133 may calculate an initial packet transmission time (or a packet transmission time of a first packet) which is randomly distributed in a continuous or discontinuous beacon interval B(n) enabling a broadcasting message to be broadcasted, and may transfer a result of the calculation to the packet generator 135. In this case, a method of calculating a packet transmission time so as to be randomly distributed in the beacon interval B(n) may use various kinds of random functions. The random functions are not a feature of the present invention, and thus, technology known to those skilled in the art is applied to a description of the method.

Moreover, the packet transmission time determiner 133 may calculate a packet transmission time of a second packet which is to be allocated to a beacon interval B(n+1) succeeding the beacon interval B(n) on a time axis, based on an interval value set in the communication device 100.

Moreover, when the packet transmission time of the second packet is allocated to a transmission-unable interval X(n) succeeding the beacon interval B(n) in a case where a beacon interval of a broadcasting message is discontinuous, the packet transmission time determiner 133 may determine a packet transmission time so as to be reallocated to an n+1st beacon interval B(n+1) succeeding the transmission-unable interval X(n) on the time axis. In this case, a method of calculating a packet transmission time so as to be reallocated to the beacon interval B(n+1) may use a modulo function or a random function.

Moreover, the packet transmission time determiner 133 may calculate an initial packet transmission time (or a packet transmission time of a first packet) of an initial packet which is randomly distributed in a continuous or discontinuous beacon interval, based on the channel state transferred from the channel state sensing unit 131.

The packet generator 135 may receive the packet transmission time determined by the packet transmission time determiner 133 and may sequentially generate packets (first and second packet) which are to be transmitted at the received packet transmission time.

The memory 140 may store the interval value set in the communication device 100, a program for the modulo function, a program for the random function, various kinds of commands for executing the programs, and/or the like. The memory 140 may include a nonvolatile memory and a volatile memory.

The communicator 150 may transmit each of the packets (the first and second packets) sequentially generated by the packet generator 135 at a packet transmission time based on self-decision. The communicator 150 may include a modem, an amplifier, a filter, and frequency conversion components, which are suitable for supporting wireless transmission. The communicator 150 may transmit a packet at the packet transmission time based on self-decision by using various multiple access methods such as time division multiple access (TDMA), carrier sense multiple access (CSMA), and orthogonal frequency division multiple access (OFDMA), based on a transmission method.

The communication device 100 configured with the above-described elements can be understood as various electronic devices. Examples of the electronic devices may include, for example, at least one of a smartphone, a tablet personal computer (PC), a mobile phone, a video phone, a television (TV) terminal having a communication function, an e-book reader, a desktop PC, a laptop PC, a netbook PC, a workstation, a server, a personal digital assistant (PDA), a portable multimedia player (PMP), an MP3 player, a mobile medical device, a camera, and a wearable device

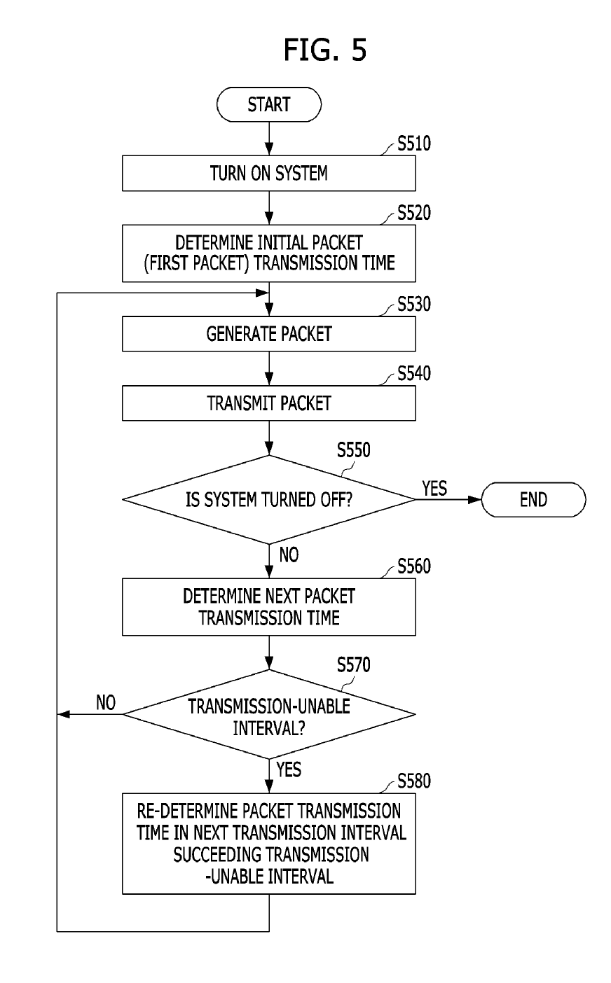

FIG. 5 is a flowchart illustrating a packet transmission method according to an embodiment of the present invention. Also, unless specially described, an element for performing each step illustrated in FIG. 3 may be assumed as the communication device 100 or the controller 130 included in the communication device 100 illustrated in FIG. 4.

Referring to FIG. 5, first, when a system associated with transmission of a packet (data or a broadcasting message) is turned on in step S510, an operation of determining a packet transmission time (hereinafter referred to as a first packet transmission time) of an initial packet (or a first packet) may be performed. Here, a method of determining the first packet transmission time may use a random function. Based on the random function, the first packet transmission time may be randomly determined in an nth transmission-enabled interval. In this manner, since the packet transmission time is randomly determined, packet transmission times respectively determined in a plurality of communications may be distributed in the nth transmission-enabled interval. Accordingly, a collision between packets transmitted by communication devices is prevented.

Subsequently, in step S530, when the first packet transmission time is determined, an operation of generating a first packet may be performed.

Subsequently, in step S540, when the first packet is generated, an operation of transmitting the generated first packet may be performed. In this manner, since a packet is generated after the packet transmission time is determined, a generated packet may be immediately transmitted at the first packet transmission time without standing by in a transmission buffer.

Subsequently, in step S550, an operation of checking whether the system is changed to an OFF state may be performed. When the system is changed to the OFF state, a series of operations associated with packet transmission may end, and when the system maintains an ON state, an operation of determining a packet transmission time (hereinafter referred to as a second packet transmission time) of a next packet (hereinafter referred to as a second packet) which is to be transmitted after an initial packet may be performed in step S560. Here, the second packet transmission time may be determined by, for example, a method of adding a predetermined interval value to a time value corresponding to the randomly determined first packet transmission time. Interval values may differ by communication devices.

In step S570, an operation of checking whether the determined second packet transmission time is allocated to a transmission-unable interval may be performed. When it is checked that the second packet transmission time is allocated to the transmission-unable interval, namely, when it is checked that the second packet transmission time is applied to a transmission-enabled interval, steps S530, S540, S550, and S560 may be sequentially performed again. In step S540, the generated second packet may be immediately transmitted at the determined second packet transmission time without transmission standby.

When it is checked that the second packet transmission time is allocated to the transmission-unable interval, an operation of re-determining the second packet transmission time in a next beacon interval succeeding the transmission-unable interval may be performed in step S580. Subsequently, when the second packet transmission time is re-determined, the second packet may be generated in step S530, and the generated second packet may be immediately transmitted at the re-determined second packet transmission time in step S540.

The above-described steps S530 to S540 and S560 to S580 may be sequentially repeated until the system is changed to the OFF state in step S550.

As described above, according to the embodiments of the present invention, a communication device may determine a packet transmission time and then may generate a packet, thereby minimizing a transmission delay.

Moreover, according to the embodiments of the present invention, a communication device may distribute and broadcast a packet in a whole beacon interval, thereby preventing a packet collision from occurring when a plurality of communication devices transmit a broadcasting message.

Moreover, according to the embodiments of the present invention, without a coordinator, communication devices reduce a packet transmission delay and prevent a packet collision, based on self-decision.

Moreover, according to the embodiments of the present invention, a problem where a packet transmission time of a broadcasting message is determined in a transmission-unable interval of the broadcasting message is solved.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet transmission method of a communication device for preventing a packet collision from occurring when a plurality of communication devices periodically broadcast a broadcasting message in a wireless network environment, the packet transmission method comprising:
randomly determining a first packet transmission time of a first packet which is to be transmitted in an nth beacon interval;
generating the first packet; and
transmitting the first packet at the first packet transmission time.

2. The packet transmission method of claim 1, wherein the determining comprises, by using a random function, determining the first packet transmission time to be randomly distributed in the beacon interval.

3. The packet transmission method of claim 1, wherein the generating comprises generating the first packet after the first packet transmission time is randomly determined.

4. The packet transmission method of claim 1, wherein the transmitting comprises, when the first packet is generated, immediately transmitting the first packet at the first packet transmission time without transmission standby.

5. The packet transmission method of claim 1, further comprising:
determining a second packet transmission time of a second packet which is to be transmitted in an n+1st beacon interval;
generating the second packet after the second packet transmission time is determined; and
immediately transmitting the generated second packet at the second packet transmission time,
wherein the determining of the second packet transmission time comprises adding a predetermined interval value to a time value representing the randomly determined first packet transmission time to determine the second packet transmission time.

6. The packet transmission method of claim 5, wherein the n+1st beacon interval succeeds the nth beacon interval on a time axis.

7. The packet transmission method of claim 1, further comprising:
determining a second packet transmission time of a second packet which is to be transmitted in an n+1st beacon interval;
generating the second packet after the second packet transmission time is determined; and
immediately transmitting the generated second packet at the second packet transmission time,
wherein
the determining of the second packet transmission time comprises:
adding a predetermined interval value to a time value representing the randomly determined first packet transmission time to determine the second packet transmission time; and
when the determined second packet transmission time is in a transmission-unable interval, re-determining the second packet transmission time to be allocated to the n+1st beacon interval.

8. The packet transmission method of claim 7, wherein the re-determining comprises, by using a random function, re-determining the second packet transmission time to be randomly distributed in the n+1st beacon interval.

9. The packet transmission method of claim 1, wherein the wireless network environment is a network environment having no coordinator.

10. A communication device for preventing a packet collision from occurring when a plurality of communication devices periodically broadcast a broadcasting message in a wireless network environment, the communication device comprising:
a controller randomly determining a first packet transmission time of a first packet which is to be transmitted in an nth beacon interval, and generating the first packet; and
a communicator immediately transmitting the generated first packet at the first packet transmission time without transmission standby.

11. The communication device of claim 10, wherein whenever the communication device is reset, the controller determines the first packet transmission time irrespective of a packet transmission time which is determined before the communication device is reset.

12. The communication device of claim 10, further comprising: a memory storing a random function for determining the first packet transmission time to be randomly distributed in the beacon interval,
wherein the controller determines the first packet transmission time by using the random function provided from the memory.

13. The communication device of claim 10, wherein
the controller determines a second packet transmission time of a second packet which is to be transmitted in an n+1st beacon interval, and generates the second packet after the second packet transmission time is determined, and
the communicator immediately transmits the generated second packet at the second packet transmission time.

14. The communication device of claim 13, wherein the controller adds a predetermined interval value to a time value representing the randomly determined first packet transmission time to determine the second packet transmission time.

15. The communication device of claim 10, wherein
the controller adds a predetermined interval value to a time value representing the randomly determined first packet transmission time to determine a second packet transmission time of a second packet which is to be transmitted in an n+1st beacon interval,
when the determined second packet transmission time is in a transmission-unable interval, the controller re-determines the second packet transmission time to be allocated to the n+1st beacon interval and generates the second packet after the second packet transmission time is re-determined, and
the communicator immediately transmits the generated second packet at the second packet transmission time.

16. The communication device of claim 15, wherein by using a random function, the controller re-determines the second packet transmission time to be randomly distributed in the n+1st beacon interval.
